(19) United States
(12) Patent Application Publication
(10) Pub. No.: US 2026/0170818 A1
(43) Pub. Date: Jun. 18, 2026

(54) AMBIGUITY DETECTION AND SUPPRESSION IN SAR IMAGES

(71) Applicant: ICEYE OY, Espoo (FI)

(72) Inventors: Tapio Friberg, Espoo (FI); Andrea Radius, Espoo (FI); Muhammad Irfan Ali, Espoo (FI)

(21) Appl. No.: 19/125,231

(22) PCT Filed: Oct. 30, 2023
(86) PCT No.: PCT/EP2023/080282

§ 371 Date: Apr. 28, 2025

(30) Foreign Application Priority Data
Nov. 4, 2022 (GB) 2216492.5

(51) Int. Cl. G06V 10/82; G06F 18/24

(52) U.S. Cl. CPC G06V 10/82; G06F 18/24

(57) ABSTRACT

A computer-implemented method and system for detecting and suppressing azimuth ambiguities in synthetic aperture radar “SAR” single look complex image data includes obtaining SAR single look complex image data; transforming the SAR single look complex image data to obtain a Doppler spectrum in the frequency domain spectrum for detecting azimuth ambiguities by performing a Fourier transform operation in the azimuth direction on the image data. The method also includes extracting phase information from the Doppler spectrum; detecting, in the Doppler spectrum, one or more azimuth ambiguities; and suppressing the one or more azimuth ambiguities to obtain corrected data. The method also includes applying an ambiguity suppression machine learning model and reinstating the phase information after suppressing the azimuth ambiguities such that the phase information of the Doppler spectrum is conserved.

### TECHNICAL FIELD

The invention relates to a computer-implemented method, system, and computer-readable medium for detecting and suppressing ambiguities in synthetic aperture radar images.

### BACKGROUND OF INVENTION

A Synthetic Aperture Radar (SAR) can be used to image an area on Earth, also known as a target area, by transmitting radar beams and recording the return echoes, i.e., returned radar energy, from those transmitted beams. SAR systems can be installed on airborne platforms such as aircraft, as well as in satellites operating from space. Various modes of operating the SAR can be used, such as such as stripmap, spotlight, ScanSAR (Scanning Synthetic Aperture Radar), and TOPS (Terrain Observation with Progressive Scan SAR).

A SAR is typically carried on board a moving platform, such as a satellite, and therefore moves with respect to a target on Earth to be imaged. As the platform moves, the SAR antenna location relative to the target changes with time and the frequency of received signals changes due to the Doppler effect. Thus the received echoes have a spectrum of frequencies.

Typically, a SAR system transmits radio-frequency radiation in pulses and records the returning echoes. Data derived from the returning echoes is sampled and stored for processing in order to form an image. Ambiguities can arise in the data and the images, for example from radar echoes backscattered from points not in the main target imaging area. These ambiguities can arise because it is difficult to perfectly direct a radar beam only to the target image area. In reality, the radar beam has sidelobes that also illuminate areas outside of the desired imaging area, resulting in radar echoes from these “ambiguous” areas that are then mixed in with the returns from the “unambiguous” areas. These echoes from undesired regions, which may be from previous and later transmitted pulses, can include ambiguities in both the azimuth and range directions. Ambiguities can cause an object or feature on the ground to appear in multiple positions in the image, only one of which is the true location. Even though the amplitude of some of these ambiguous signals may be smaller than the non-ambiguous signals, they can cause confusion in the image and degrade the quality of the image. As such, it would be desirable to be able to detect the ambiguities in the SAR image, as well as to be able to suppress the ambiguities.

One approach to reducing ambiguities in the first place is to design the SAR system by selecting the antenna size and the Pulse Repetition Frequency (PRF) accordingly. For example, during the phase of antenna design the azimuth ambiguity issue can be mitigated by setting the PRF properly based on the antenna length. In general, an increase in the PRF reduces the occurrence of azimuth ambiguities. However, an increase in the PRF also causes more range ambiguities. As such, there are trade-offs in the design and a balance between the two types of ambiguities must be found. Unfortunately, the proper design may also not be in line with the requirements of modern SAR platforms, such as small satellites. New SAR satellite constellations are equipped with smaller antennas compared to their predecessors, imposing constraints that restrict these conventional methods of suppressing ambiguities. Since it is impossible to design a SAR system to eliminate ambiguities entirely due to the physical nature of SAR and the trade-offs involved, particularly for small SAR satellites, other approaches are being developed to detect and suppress ambiguities.

Another approach is to detect and remove ambiguities through post-processing of the SAR data. For example, some algorithms have been proposed to estimate the local azimuth ambiguity-to-signal ratio (AASR). However, the existing algorithms for detecting and suppressing ambiguities are not able to suppress large ambiguities, and they can also cause a reduction of the azimuth resolution. In addition, some of the existing algorithms for ambiguity detection and suppression are based on the assumption that the ambiguous signals are located in specific areas of the signal spectrum depending on the antenna pattern. In these proposed techniques filters built based on knowledge of the antenna design are used to discriminate the ambiguous spectrum, allowing the detection and selective suppression of the ambiguities. The limitation of some of these suppression methods is a low sensitivity to weak and small ambiguities, as well as the fact that they are specific only to a particular antenna design.

Some embodiments of the invention described below solve some of these problems. However, the invention is not limited to solutions to these problems and some embodiments of the invention solve other problems.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a computer-implemented method of detecting and suppressing ambiguities in synthetic aperture radar “SAR” single look complex image data, the method comprising: obtaining SAR single look complex image data, transforming the SAR single look complex image data to obtain a frequency domain spectrum for detecting ambiguities, detecting, in the frequency domain spectrum, one or more ambiguities, and suppressing the one or more ambiguities to obtain corrected data, wherein: the detecting comprises applying an ambiguity detection machine learning model, and/or the suppressing comprises applying an ambiguity suppression machine learning model.

The method according to the first aspect provides more accurate detection and better suppression than conventional techniques. Transforming the single look complex image data to a frequency domain spectrum allows the method to more easily distinguish ambiguities when compared to the single look complex image data itself, which may include ambiguities masked by real strong targets. Furthermore, using the ambiguity detection machine learning model and/or the ambiguity detection machine learning model increases the accuracy of detection and suppression of ambiguities respectively. The ambiguity detection machine learning model and the ambiguity suppression machine learning model may be used together or independently, such that only one of the two machine learning models are used.

The one or more ambiguities may comprise azimuth ambiguities and the frequency domain spectrum may comprise a Doppler spectrum. The Doppler spectrum has the frequency axis along the azimuth and the time axis along the range. In this respect, the frequency domain spectrum in the first aspect may be the Doppler spectrum.

Alternatively, the one or more ambiguities comprise radio frequency interference ambiguities and the frequency domain spectrum comprises a range spectrum. The range spectrum has the frequency axis along the range and the time axis along the azimuth. In this respect, the frequency domain spectrum in the first aspect may be the range spectrum.

Alternatively still, the frequency domain spectrum in the first aspect may comprise both the Doppler spectrum and the range spectrum, such that azimuth ambiguities are detected and suppressed in the Doppler spectrum and radio frequency interference ambiguities are detected and suppressed in the range spectrum. The method of the first aspect may thus be applied to one of or both of azimuth ambiguities and radio frequency interference ambiguities.

Detecting the one or more azimuth ambiguities may comprise applying the ambiguity detection machine learning model, configured to detect the one or more azimuth ambiguities, to the Doppler spectrum to output an indication of one or more azimuth ambiguities in the Doppler spectrum, wherein suppressing the one or more azimuth ambiguities comprises using the indication of the one or more azimuth ambiguities output by the ambiguity detection machine learning model to suppress the one or more azimuth ambiguities to obtain corrected data.

The suppressing may include either: suppressing the one or more azimuth ambiguities in the Doppler spectrum to obtain a modified Doppler spectrum; and transforming the modified Doppler spectrum to obtain the corrected data, wherein the corrected data is image data; or transforming the Doppler spectrum, including the indication of the one or more azimuth ambiguities output by the ambiguity detection machine learning model, to single look complex image data including a transformed indication of the one or more azimuth ambiguities; and suppressing the one or more azimuth ambiguities in the single look complex image data including the transformed indication to obtain the corrected data, wherein the corrected data is image data. The image data may for example be SAR SLC data, or other image data. The modified Doppler spectrum does not include the one or more ambiguities.

The suppressing may comprise applying a non-machine learning suppression algorithm to suppress the one or more azimuth ambiguities.

Suppressing the one or more azimuth ambiguities may comprise: applying the ambiguity suppression machine learning model, configured to suppress the one or more azimuth ambiguities, using the indication of the one or more azimuth ambiguities output by the ambiguity detection machine learning model.

The suppressing of the one or more azimuth ambiguities may comprise applying the ambiguity suppression machine learning model, configured to suppress the one or more azimuth ambiguities, to obtain the corrected data. The corrected data does not include the one or more ambiguities.

Detecting the one or more azimuth ambiguities may comprise applying a non-machine learning detection algorithm to output an indication of one or more azimuth ambiguities in the Doppler spectrum.

Suppressing may comprise either: suppressing, with the ambiguity suppression machine learning model, the one or more azimuth ambiguities in the Doppler spectrum to obtain a modified Doppler spectrum; and transforming the modified Doppler spectrum to obtain the corrected data, wherein the corrected data is image data; or transforming the Doppler spectrum, including the indication of the one or more azimuth ambiguities output by the non-machine learning detection algorithm, to single look complex image data including a transformed indication of the one or more azimuth ambiguities; and suppressing, with the ambiguity suppression machine learning model, the one or more azimuth ambiguities in the single look complex image data including the transformed indication to obtain the corrected data, wherein the corrected data is image data.

The method of the first aspect may further comprise masking the one or more detected azimuth ambiguities in the Doppler spectrum to produce a masked Doppler spectrum prior to suppressing, such that suppressing is performed based on the masked Doppler spectrum. The Doppler spectrum may comprise pixels. The pixels that are identified by the method as including detected ambiguities may be masked out in the masked Doppler spectrum.

The ambiguity detection machine learning model may comprise a neural network trained to detect azimuth ambiguities in Doppler spectra.

The neural network of the ambiguity detection machine learning model may be a convolutional neural network.

The convolutional neural network of the ambiguity detection machine learning model may be a U-Net convolutional neural network or a Residual U-Net convolutional neural network.

The convolutional neural network may be trained to detect azimuth ambiguities in the Doppler spectrum using detection training data, wherein the detection training data is generated using a SAR data simulator.

The ambiguity suppression machine learning model may comprise a convolutional neural network.

The convolutional neural network of the ambiguity suppression machine learning model may comprise a generative adversarial network.

The convolutional neural network of the ambiguity suppression machine learning model may be a Deep image prior convolutional neural network, configured to perform inpainting on detected azimuth ambiguities.

The convolutional neural network of the ambiguity suppression machine learning model may be a trained one-dimensional or two-dimensional convolutional neural network configured to perform inpainting on detected azimuth ambiguities; wherein the convolutional neural network is trained using suppression training data.

The suppression training data may be generated using a SAR simulator.

The transforming the single look complex image data to obtain a Doppler spectrum may comprise performing a Fourier transform operation in the azimuth direction on the image data. Where the frequency domain spectrum includes or is the range spectrum, the Fourier transform operation may be performed in the range direction on the image data.

Transforming the Doppler spectrum to obtain single look complex image data or the modified Doppler spectrum to obtain the corrected data, may comprise: performing an inverse Fourier transform operation on the Doppler spectrum or modified Doppler spectrum. A similar step may be performed with respect to the range spectrum or a corresponding modified range spectrum when detecting and suppressing radio frequency interference ambiguities.

The Doppler spectrum may include amplitude and phase information, the method further comprising: extracting the phase information from the Doppler spectrum prior to detecting the azimuth ambiguities; and reinstating the phase information after suppressing the azimuth ambiguities, such that the phase information of the Doppler spectrum is conserved.

The ambiguity suppression machine learning model may be a supervised or unsupervised machine learning model.

The method may further comprise normalizing the SAR single look complex image data. This helps the process in that strong targets are removed, allowing for easier disambiguation of the ambiguities from the non-ambiguous signal.

The method may further comprise receiving SAR raw data signals and converting the SAR raw data signals to obtain the SAR single look complex image data.

The method may further comprise producing an image using the corrected data. The image may be any type of image, or a SAR SLC image.

In a second aspect, the present disclosure provides: a computer-implemented method of detecting azimuth ambiguities in synthetic aperture radar “SAR” single look complex image data, the method comprising: obtaining SAR single look complex image data; transforming the SAR single look complex image data to obtain a Doppler spectrum; and detecting, in the Doppler spectrum, one or more azimuth ambiguities, the detecting comprising applying an ambiguity detection machine learning model configured to detect azimuth ambiguities in Doppler spectra.

The additional and/or optional features of the first aspect above may each be applied to the second aspect.

In a third aspect the present disclosure provides a computer-implemented method of suppressing azimuth ambiguities in synthetic aperture radar “SAR” single look complex image data, the method comprising: obtaining indications of one or more azimuth ambiguities in SAR single look complex image data or in a Doppler spectrum data set; and suppressing, the one or more azimuth ambiguities to obtain corrected data, the suppressing comprising applying an ambiguity suppression machine learning model configured to suppress azimuth ambiguities in SAR single look complex image data or in Doppler spectra.

The additional and/or optional features of the first aspect above may each be applied to the third aspect.

In a fourth aspect, the present disclosure provides a computing system comprising one or more processors configured to perform the method of any of the first, second or third aspects described above.

In a fifth aspect, the present disclosure provides a computer-readable medium comprising instructions which, when executed by a processor, cause the processor to carry out the method of any of the first, second or third aspects described above.

In a sixth aspect, the present disclosure provides a computer-implemented method of detecting and suppressing azimuth and/or radio frequency interference ambiguities in synthetic aperture radar “SAR” single look complex image data, the method comprising: obtaining SAR single look complex image data; transforming the SAR single look complex image data to obtain a Doppler spectrum to detect azimuth ambiguities, and/or a Range spectrum to detect radio frequency interference ambiguities; detecting, in the Doppler and/or Range spectrum, one or more azimuth ambiguities and/or radio frequency interference ambiguities respectively; and suppressing the one or more azimuth ambiguities and/or radio frequency interference ambiguities to obtain corrected data; wherein: the detecting comprises applying an ambiguity detection machine learning model; and/or the suppressing comprises applying an ambiguity suppression machine learning model.

In a seventh aspect, the present disclosure provides a computer-implemented method of detecting and suppressing azimuth ambiguities in synthetic aperture radar “SAR” single look complex image data, the method comprising: obtaining SAR single look complex image data; transforming the SAR single look complex image data to obtain a Doppler spectrum; detecting, in the Doppler spectrum, one or more azimuth ambiguities; and suppressing the one or more azimuth ambiguities to obtain corrected data; wherein: the detecting comprises applying an ambiguity detection machine learning model; and/or the suppressing comprises applying an ambiguity suppression machine learning model.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc, and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a system according to various embodiments of the disclosure;

FIG. 2 is a schematic diagram of the system according to various embodiments of the disclosure;

FIG. 3 is a flow diagram of a method according to various embodiments of the disclosure;

FIG. 4 is a flow diagram of a method according to various embodiments of the disclosure;

FIGS. 5a and 5b are flow diagrams of a method according to various embodiments of the disclosure;

FIG. 6 is a flow diagram of a method according to various embodiments of the disclosure;

FIG. 7 is a schematic diagram of a SAR SLC image and a Doppler spectrum according to various embodiments of the disclosure;

FIG. 8 is SAR SLC image data and Doppler spectrum data according to various embodiments of the disclosure;

FIG. 9 is an image of Doppler spectrum data according to various embodiments of the disclosure;

FIG. 10 is an image of normalized Doppler spectrum data according to various embodiments of the disclosure;

FIG. 11 is a schematic diagram of a neural network architecture according to various embodiments of the disclosure;

FIG. 12 includes two graphs showing the performance of the methods according to various embodiments of the disclosure;

FIG. 13 is a schematic diagram of Doppler spectrum data and modified Doppler spectrum data.

FIG. 14 is an image of Doppler spectrum data and an image of modified Doppler spectrum data according to various embodiments of the disclosure;

FIG. 15 is a zoomed-in image of modified Doppler spectra according to various embodiments of the disclosure;

FIG. 16 is a zoomed-in image of modified Doppler spectra according to various embodiments of the disclosure;

FIGS. 17a, 17b and 17c show images of Doppler spectra at various steps in the methods according to various embodiments of the disclosure;

FIGS. 18a, 18b and 18c show images of ambiguities at various steps in the methods according to various embodiments of the disclosure;

FIG. 19 shows an image of corrected data according to various embodiments of the disclosure;

FIG. 20 is a flow diagram of the inputs and outputs of a neural network according to various embodiments of the disclosure;

FIG. 21 is a flow diagram showing the inputs and outputs of two neural networks according to various embodiments of the disclosure;

FIG. 22 is a flow diagram showing a method of using a neural network according to various embodiments of the disclosure;

FIG. 23 is a flow diagram showing a method of using a neural network according to various embodiments of the disclosure;

FIG. 24 is a graph showing the performance of the neural networks according to various embodiments of the disclosure; and

FIG. 25 shows a system according to various embodiments of the disclosure.

Common reference numerals are used throughout the figures to indicate similar features.

### DETAILED DESCRIPTION

This application relates to a system and computer-implemented method for detecting and suppressing azimuth ambiguities from synthetic aperture radar “SAR” single look complex (SLC) image data.

For this purpose, a SAR may be carried on a platform travelling with respect to the surface of Earth. For example, a SAR is commonly used onboard satellites. However, the methods and systems described here are not limited to data obtained from space and may be performed on data obtained using aircraft or any other suitable platform in any environment. Thus, although the system and method are exemplified in the proceeding description of the invention as being related to a satellite, it is to be understood that there are other possible examples and implementations.

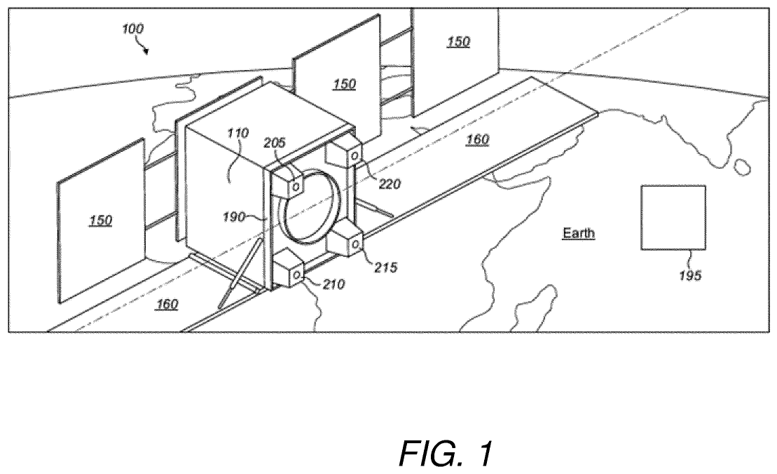

FIG. 1 is a perspective view of a satellite 100 in orbit over Earth as an example of a platform which may be used in the methods and systems described here. The satellite comprises a body 110 and “wings” 160. One or more SAR antennas may be mounted on the satellite wings. The satellite 100 additionally comprises a propulsion system 190 shown to be mounted on the body 110 on the surface opposite the solar panels 150. The propulsion system can comprise thrusters 205, 210, 215, 220, which are part of the system for operating and manoeuvring the satellite 100 to position it appropriately for capturing SAR imagery of the Earth. A computing system may be housed in the satellite body 110 which may be configured to implement some or all of the operations described here. In some embodiments of the invention, there is also provided a ground station and/or computing systems 195, distributed computing systems or servers configured to post-process the SAR data received from the satellite 110 and/or to implement some or all of the operations described here.

As will be understood, a SAR is operated to alternate periodically between transmission mode in which a pulse of radiation is directed towards the surface of Earth and reception mode in which radiation reflected from the surface is received.

As will also be understood, to create a SAR image, successive pulses of radio waves are transmitted to “illuminate” a target and the echo of each pulse is received and recorded. The pulses can be transmitted and the echoes can be received using a single beam-forming antenna. As the SAR is carried on board a moving platform, such as a satellite, and therefore moves with respect to the target, the antenna location relative to the target changes with time and the frequency of received signals changes due to the Doppler Effect. Signal processing of the successive recorded radar echoes allows the combination of recordings from multiple antenna positions thereby forming the synthetic antenna aperture to allow creation of high resolution images comparable to what would be achievable with a larger but non-moving antenna.

An area currently captured by the SAR is known as a footprint. A direction along the flight direction of the SAR is usually referred to as azimuth or along track. A direction transverse to the flight direction is usually referred to as range, elevation or cross-track. A direction opposite to the flight direction corresponds to the backward azimuth direction.

Ambiguities in SAR images are an aliasing effect due to the pulsed operation of the radar system. The effect of ambiguities is to create artefacts in images that do not accurately represent the ground being imaged. For example, an image may contain a feature that appears more than once. In one example of an ambiguity that can arise, a dense urban area can appear in its correct location, and then an artefact of that part of the image can also appear elsewhere in the image, for example over a smooth body of water, which is clearly incorrect. This “ambiguity” degrades the quality of the SAR image.

Spaceborne systems can produce two types of ambiguities: azimuth ambiguities or Doppler ambiguities that are related to the motion of the satellite in the azimuth direction, and range ambiguities that are related to the time delay of echoes from different distances in the range or cross-track direction of a side-looking SAR satellite. Ambiguities can be reduced through careful antenna design, for example by selecting the antenna size and pulse repetition frequency (PRF) carefully. For example, increasing the PRF will tend to reduce the occurrence of azimuth ambiguities. However, increasing the PRF also has the adverse effect of increasing the occurrence of range ambiguities. Therefore, a balance needs to be struck between designing the system to reduce azimuth ambiguities while not causing too many range ambiguities, and it is impossible to fully compensate for both types of ambiguities through the design of the SAR system alone. This is particularly true in light of modern satellites that have requirements for smaller antennas. In fact, the design constraints of smaller lighter satellites have for example tended to increase the occurrence of azimuth ambiguities. Being able to detect ambiguities is important for accessing the quality of SAR image. Also, being able to detect and then suppress ambiguities is desirable for removing the ambiguities from the image.

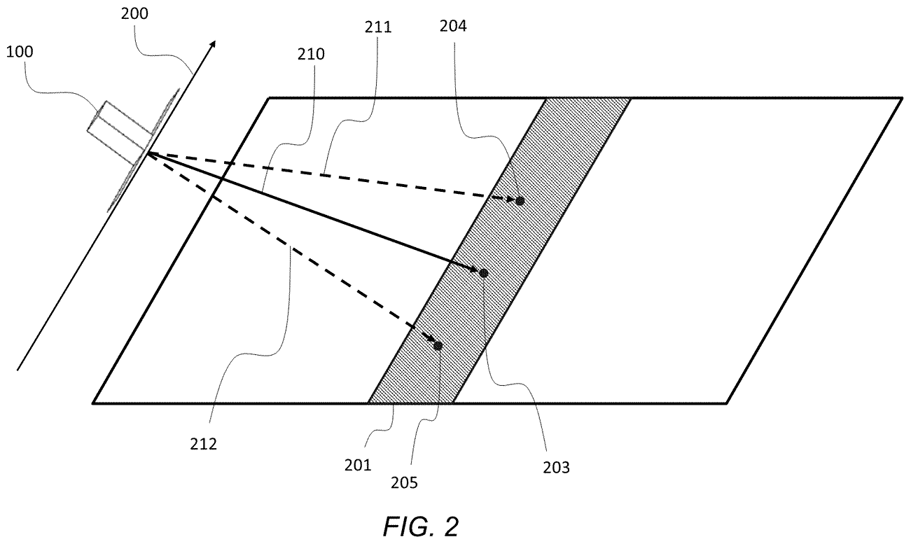

FIG. 2 shows an example of satellite 100 operating in a classic strip map mode, where the SAR beam is swept along one swath along the ground (represented by shaded area 201) as the satellite travels in its orbital path. In this mode, the SAR beam will typically travel in the azimuth direction at the same speed as the SAR platform. The time during which a radar beam collects data during a forward sweep is called the integration time. Many pulses may be recorded during the integration time. Examples according to the current disclosure can be equally applied to any SAR mode, including for example spotlight mode, ScanSAR (Scanning Synthetic Aperture Radar) mode, and TOPSAR (Terrain Observation with Progressive Scans SAR) mode. In an example, the satellite 100 is directing a radar beam 210 orthogonally to the satellite's direction of motion 200 and records the radar echoes from point 203 to determine information about the Earth's surface at that location. This information is then formed into an image of the Earth's surface. However, due to the difficulties of forming a perfectly directed radar beam, there are typically sidelobes to the main beam, represented in the azimuth direction by lines 211 and 212, that can cause echoes from points 204 and 205 to be mixed in with the echoes from point 203. This creates azimuth ambiguities in the signal because features (e.g., a building) located at point 204 can show up in the SAR image at both point 203 and 204.

In addition to ambiguities arising from SAR antenna beam pattern, other contributors to the occurrence of ambiguities in SAR images relate to the processing of the SAR data. For example, ambiguities can arise as a result of Range Migration Compensation (RMC) algorithms and errors in Doppler centroid estimation. Unlike the first source of ambiguities that arise due to a physical property of the antenna beam, these ambiguities arise due to processes required to turn the raw SAR data into an image. In particular, azimuth ambiguities and radio frequency interference (RFI) can produce severe artifacts in SAR images.

The SAR images are thus datasets that include the sum of a main signal from the area being imaged and the signal generated by the ambiguities. However, separating out these two signals can be difficult, particularly in the image domain. Indeed, detecting and Suppressing ambiguities in SAR SLC data is a non-trivial problem.

Embodiments according to the current disclosure provide a computer-implemented method and system for detecting azimuth ambiguities, and/or suppressing the ambiguities, using post-processing techniques, and in particular by using post-processing techniques with machine learning. The ambiguities may be detected and suppressed in the image domain, the frequency domain, or a combination of both the image and frequency domain. The image domain refers to datasets comprising SAR SLC image data and is formed from raw SAR data. As noted above, the SAR SLC image data represents a realistic view of a target object (such as an area of the Earth) observed by the SAR antenna. The frequency domain comprises datasets arranged on axes of time and frequency. This can include, for example, datasets that have been transformed from the image domain, for example, by applying a Fast Fourier Transform (FFT). The frequency domain comprises a Doppler spectrum (or Doppler domain) in the Azimuth direction. Thus, applying a FFT in azimuth direction to the dataset in the image domain results in a Doppler spectrum in the frequency domain.

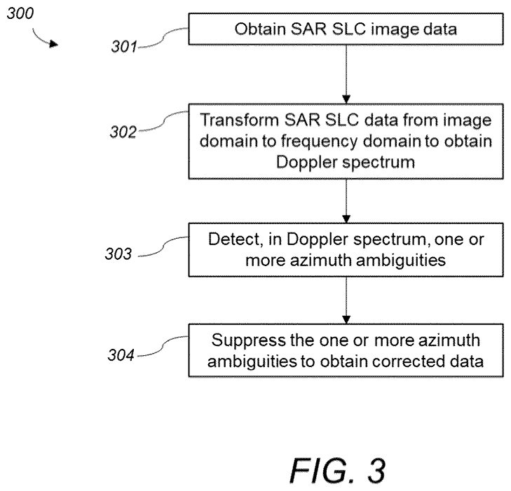

The computer implemented method according to various embodiments of this disclosure will now be described in more detail. A first embodiment of the method is described here with reference to FIG. 3, which shows a flow diagram of the method 300. The method 300 is performed by one or more computer devices, which need not be co-located with the SAR antenna.

At a first step 301 of the method 300, SAR SLC image data is obtained. The process of forming the SAR SLC image data may or may not be performed as part of the method. This process may be performed separately or by a third party for example. Alternatively, the SAR SLC image data is obtained from received SAR signals from a SAR apparatus, such as the satellite 100 shown in FIG. 1. The SAR SLC data forms an image in the image domain, which may include one or more azimuth ambiguities. These ambiguities may be formed from echoes and the like and can occlude or otherwise detrimentally affect the quality and accuracy of the image.

In a second step 302, the SAR SLC image data is transformed to obtain a Doppler spectrum. In particular, a Fast Fourier Transform (FFT) in the azimuth direction may be performed to generate the Doppler spectrum of the SAR SLC data in the frequency domain. Each pixel of the SAR SLC data contains the magnitude and phase of both main and the ambiguous signals, as well as phase information. Transformation of the SAR SLC data into the frequency domain makes detecting some ambiguities, for example azimuth ambiguities, much easier. In particular, using data in the frequency domain according to the current disclosure allows a machine learning model to decouple the ambiguous signals from the main signal, and thus detect the azimuth ambiguities.

At a third step 303, a detection process is performed to detect azimuth ambiguities in the Doppler spectrum. In particular, portions of the Doppler spectrum in which azimuth ambiguities reside are identified. The process of detecting azimuth ambiguities may be performed using a classical method, such as a non-machine learning algorithm. In various embodiments of the present disclosure, the process of detecting the azimuth ambiguities is performed by a machine learning model configured to detect azimuth ambiguities, otherwise referred to here as an ambiguity detection machine learning model. The ambiguity detection machine learning model is explained in more detail later.

At a fourth step 304, a suppression process is performed to suppress the detected azimuth ambiguities. In particular, portions of the Doppler spectrum in which azimuth ambiguities have been detected are subject to suppression by a suppression process. The process of suppressing the azimuth ambiguities may be performed using a classical method, such as a non-machine learning algorithm. In various embodiments of the present disclosure, the process of suppressing the azimuth ambiguities is performed by a machine learning model configured to suppress azimuth ambiguities, otherwise referred to here as an ambiguity suppression machine learning model. The ambiguity suppression machine learning model is explained in more detail later.

In the above third and fourth steps 303 and 304, there are several possibilities that correspond to the embodiments described here. Firstly, detection and suppression may be performed by the ambiguity detection machine learning model and the ambiguity suppression machine learning model respectively. In this instance, both machine learning models are used, and the output of the ambiguity detection machine learning model is used, directly or indirectly, as the input for the ambiguity suppression model. Secondly, detection may be performed with the ambiguity detection machine learning model and suppression may be performed with a classical approach, without using machine learning. Thirdly, detection may be performed with a classical approach, without using machine learning, and suppression may be performed with the ambiguity suppression machine learning model. Detecting and suppressing classically, without machine learning in any aspect of the process, does not form part of the embodiments of this disclosure. Thus, machine learning is applied to the detection, suppression, or both.

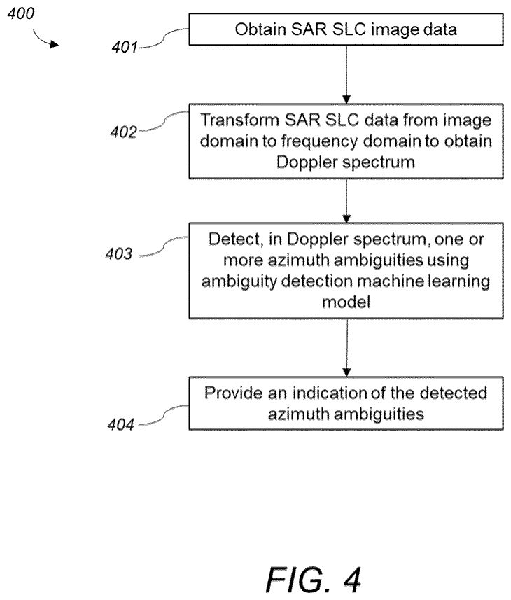

In some embodiments of this disclosure, only detection or only suppression is performed. FIG. 4 shows a method 400 according to an embodiment of this disclosure, whereby detecting is performed and suppressing is not.

In a first step 401, SAR SLC image data is obtained. The process of forming the SAR SLC image data may or may not be performed as part of the method. This step is the same as the first step 301 of the method 300 as set out above.

In a second step 401, the SAR SLC image data is transformed to obtain a Doppler spectrum. This step is the same as second step 302 of the method 300 as set out above.

In a third step 403, the detection process is performed using the ambiguity detection machine learning model in the Doppler spectrum. The ambiguity detection machine learning model is configured to detect one or more azimuth ambiguities in Doppler spectra.

In a fourth step 404, an indication of the one or more detected ambiguities is provided. The indication of the one or more detected ambiguities is originally in the Doppler spectrum, and may be generated by masking the detected ambiguities in the Doppler spectrum. For example, the output of the ambiguity detection machine learning model may be used to produce a modified Doppler spectrum whereby the detected ambiguities are masked with a pixel value that is notably different from the surrounding pixels of the Doppler spectrum where no ambiguities are detected. The mask may produce any suitable pixel values for the pixels associated with detected ambiguities.

The modified or masked Doppler spectrum that forms the indication of the detected ambiguities may be output for display, saved to memory or transmitted as an output. Alternatively, in an additional optional step, the modified or masked Doppler spectrum may be transformed back to SAR SLC image data, such that the indication present in the masked or modified Doppler spectrum is transformed to a corresponding indication in the image domain.

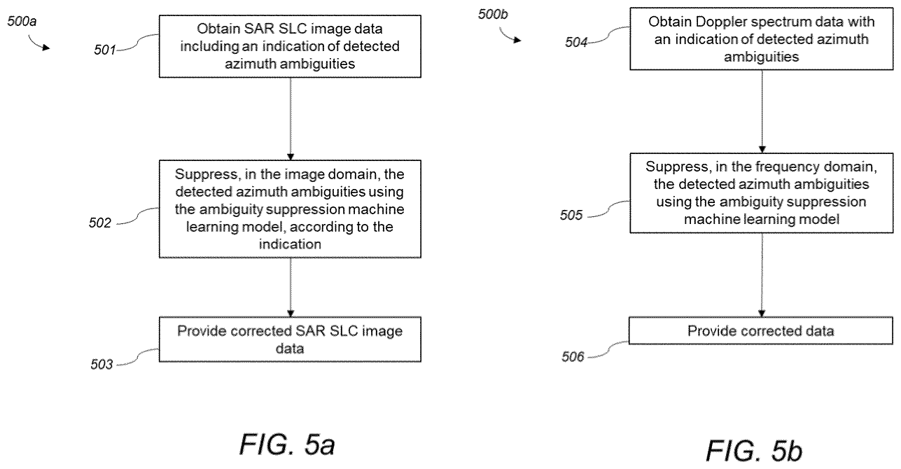

According to other embodiments of this disclosure, FIGS. 5a and 5b show two related methods 500a and 500b whereby suppression is performed but detection is not.

Firstly, with regard to FIG. 5a, a first step 501 includes obtaining SAR SLC image data including an indication of one or more detected azimuth ambiguities. Thus azimuth ambiguities have already been detected, by any suitable process, prior to the start of the method 500a. This data may be received from a third party, for example. The indication may include any suitable indication, such as a masked, highlighted or removed area or portion of an image.

In a second step 502, the one or more azimuth ambiguities are suppressed in the image domain using the ambiguity suppression machine learning model, according to the indication provided in the first step 501. In other words, the SAR SLC data is modified to suppress the indicated ambiguities, using machine learning. The ambiguity suppression machine learning model in this instance is configured to suppress azimuth ambiguities in the image domain, and is described in more detail later.

In a third step 503, as a consequence of the suppression by the ambiguity suppression machine learning model, a corrected SAR SLC image is provided, whereby the SAR SLC image no longer includes the azimuth ambiguities. The corrected SAR SLC image may be displayed on a display, saved to memory, or transmitted to another computing device for storage and further use.

In the method 500a, the input to the method is SAR SLC image data and the output is corrected SAR SLC image data.

The method 500b, as shown in FIG. 5b, differs from the method 500a in that the input is in the frequency domain rather than the image domain. In a first step 504 of the method 500b, Doppler spectrum data including an indication of one or more detected azimuth ambiguities is obtained. This data may be received from a third party, for example. Thus azimuth ambiguities have already been detected, by any suitable process, prior to the start of the method 500a. The indication may include any suitable indication, such as a masked, highlighted or removed area or portion of the Doppler spectrum data.

In a second step 505, the one or more azimuth ambiguities are suppressed in the frequency domain using the ambiguity suppression machine learning model, according to the indication provided in the first step 504. In other words, the Doppler spectrum data is modified to suppress the indicated ambiguities, using machine learning. The ambiguity suppression machine learning model in this instance is configured to suppress azimuth ambiguities in the frequency domain, and is described in more detail later.

In a third step 506, corrected data is provided, as a consequence of the azimuth ambiguities having been suppressed by the ambiguity suppression machine learning model. Initially, this corrected data is in the form of a modified Doppler spectrum, whereby the azimuth ambiguities present in the original input Doppler spectrum are suppressed in the modified Doppler spectrum. This modified Doppler spectrum may form the final corrected data for display, storage, and/or transmission. Alternatively, the modified Doppler spectrum may be transformed from the frequency domain to the image domain, to obtain the SAR SLC corrected data. This transformation may be done by an inverse fast Fourier transform (IFFT), for example. The SAR SLC corrected data may then form the final corrected data for display, storage and/or transmission.

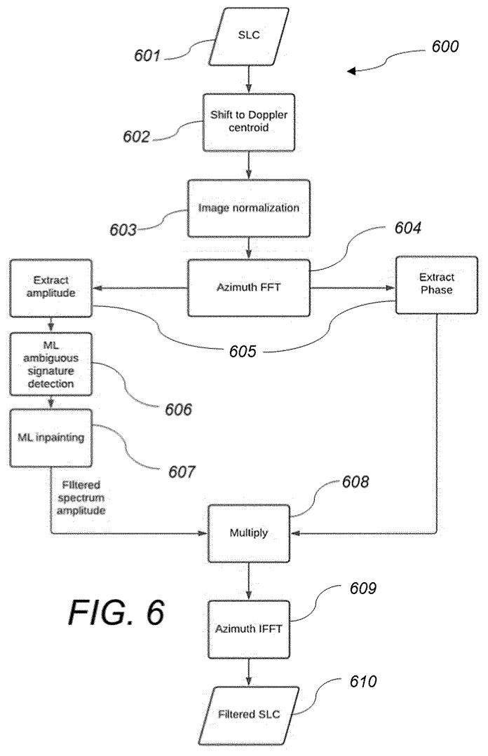

In addition to the steps of the methods set out with respect to FIGS. 3 to 5b, additional steps may be implemented as will now be discussed with respect to FIG. 6.

FIG. 6 is a flow diagram showing a method 600 according to various embodiments. It is to be understood that any one or more of the method steps of the method 600 may be included with any of the methods described above with reference to FIGS. 3 to 5b.

In a first step 601 of the method 600, SAR SLC image data is obtained. The SAR SLC image data may be generated from received raw SAR data. This step is the same as the first step 301 of the method 300 described above.

In a second step 602, the SAR SLC image data is shifted to the Doppler centroid, such that the Doppler spectrum of the data has in its centre the Doppler centroid frequency instead of the zero Doppler frequency. In other words, the shift to the Doppler centroid makes the Doppler spectrum become perfectly centred. This allows the detection and suppression to be performed on the same parameterised environment each time. A Fast Fourier Transform (FFT) in the azimuth direction may later be performed in step 604 to generate the Doppler spectrum of the SAR SLC data in the frequency domain. As such, the shift to the Doppler centroid may be performed in the image domain.

In a third, additional step 603, the image is normalised. In particular, a dedicated normalization filtering process is applied to the SAR SLC data. The dedicated normalization filtering enhances the ambiguous signatures of azimuth ambiguities in the Doppler spectrum, even when such ambiguities are masked by strong targets (bright areas). The normalisation filtering is performed in the image domain. Given the complex data ζ(s,t), the normalization is obtained dividing by the absolute value of the data:

$${ζ}_{N} ( s , t ) = \frac{ζ ( s , t )}{\vert ζ ( s , t ) \vert} \qquad ( 1 )$$

The normalization increases the visibility of the ambiguities in the background of strong (bright) targets. This is particularly useful when the data is captured from environments with strongly reflecting targets (such as buildings in urban areas). Thus, the normalization filtering process can improve the process of detecting azimuth ambiguities in the post-normalized data.

In a fourth step 604, an Azimuth FFT is applied to the image data in order to obtain a Doppler spectrum. Step 604 is thus the same as the second step 302 of the method 300. It is to be understood that an FFT may be applied in the azimuth, to obtain the Doppler spectrum that has the frequency axis along the azimuth and the time axis along the range; or alternatively, the FFT may be applied in the range, to obtain a range spectrum that has the frequency axis along the range and the time axis along the azimuth. The range spectrum allows for detection and suppression of radio frequency interference ambiguities.

In a fifth step 605, the amplitude and phase are extracted from the Doppler spectrum data and separated, prior to the detection and suppression processes.

In a sixth step 606, the amplitude data of the Doppler spectrum is input to the ambiguity detection machine learning model. The ambiguity detection machine learning model is thus configured to process the amplitude data of the Doppler spectrum to identify azimuth ambiguities. The ambiguity detection machine learning model then outputs one or more indications corresponding to detected azimuth ambiguities. The indications may be represented in the amplitude data of the Doppler spectrum by applying a mask to the Doppler spectrum, whereby the mask redefines the amplitude values of the pixels of the Doppler spectrum that have been identified (detected) as being an azimuth ambiguity. For example, all pixels for which an azimuth ambiguity has been detected may be masked such that their pixel value is 256 (white). In some embodiments, the output of the ambiguity detection machine learning model is a probability map equal in size to the size of the Doppler spectrum. Each pixel in the probability map has a value between 0 and 1 ([0.0, 1.0]) which denotes the probability of that pixel being part of an ambiguity. The probability map may then be converted to a mask by selecting a threshold, typically 0.5, such that pixels that have over 50% probability of being ambiguous are so. This threshold can be tuned to make the system either more sensitive or more robust. The mask produced by the routine is a Boolean mask, providing True or False results for each pixel with respect to the presence of an ambiguity. This mask can then be used to convert to an image of distinct pixels representing ambiguities and non-ambiguities, for example black and white. This image of distinct pixels may then be used as the input for the ambiguity suppression machine learning model.

In a seventh step 607, the output of the ambiguity detection machine learning model is used by the ambiguity suppression machine learning model to suppress the detected azimuth ambiguities from the Doppler spectrum. The output of the ambiguity detection machine learning model, meaning the indication of the one or more detected azimuth ambiguities, may be used directly as the input for the ambiguity suppression machine learning model, or indirectly, should any intermediate processing be performed on the output of the ambiguity detection machine learning model. For example, the masking process described above may be considered an intermediate processing step between detection and suppression. The output of the ambiguity suppression machine learning model is a modified Doppler spectrum with modified amplitude values, wherein the detected ambiguities have been suppressed.

In an eighth step 608, the modified amplitude values are re-combined with the phase information that was extracted at the fourth step 604. In particular, the phase is recombined according to the following equation:

$${Z}_{filt} ( {f}_{D} , t ) = \vert {Z}_{modif} ( s , t ) \vert \cdot {e}^{( ∠Z ( {f}_{D} , t ) )} \qquad ( 2 )$$

where Z_{modif} is the modified amplitude of the Doppler spectrum and Z is the original Doppler spectrum. To obtain a modified image in the image domain it is useful to recombine the phase in this way, since the phase provides useful information in the image domain, for calculating more accurate distances to targets for example, as well as for applying techniques such as Interferometric Synthetic Aperture Radar (InSAR) that make use of the phase information.

In an ninth step 609, the modified Doppler spectrum, with the phase information recombined with the modified amplitude data, is converted back to the image domain to form SAR SLC image data. To do this, an inverse Fast Fourier Transform may be performed.

In a tenth step 610, a filtered SAR SLC image is provided, or in other words, corrected image data without azimuth ambiguities. This corrected image data may be stored, displayed or transmitted as necessary.

The method described above with respect to FIG. 6, according to the embodiments of this disclosure, provides improved detection and suppression of azimuth ambiguities by applying a machine learning model configured to detect azimuth ambiguities and another machine learning model configured to suppress ambiguities present in the Doppler spectrum, to ultimately obtain corrected image data.

This method has advantages over traditional methods for detecting and suppressing ambiguities in SAR data in the image domain. SAR information is typically communicated in the form of an image, and traditional image-domain techniques may thus be used to detect and suppress ambiguities. For example, a typical approach would be to use SAR amplitude data to attempt to detect azimuth ambiguities. However, the performance of these techniques may be inadequate because of the difficulty of identifying, particularly on a pixel-by-pixel basis, how much of the contribution to the amplitude (brightness) of that pixel is attributable to an ambiguity and how much is attributable to a real feature at the location represented by that pixel. In short, it is difficult to decouple the ambiguities from the non-ambiguous signal in the image domain. By converting the data to the frequency domain, and obtaining a Doppler spectrum, it can be easier to distinguish between ambiguities and the non-ambiguous signal.

The above-described methods provide improvements in detecting and/or suppressing azimuth ambiguities in SAR images. Additionally, radio frequency interference (RFI) artifacts have strong characteristic signals in the frequency domain in the Range spectrum, and can thus be detected and suppressed in a similar manner. Thus, the above methods can also be applied to RFI ambiguities as well as azimuth ambiguities if applied to the Range spectrum instead of to the Doppler spectrum. The above description, and particularly the description that refers to FIGS. 3 to 6 is thus also applicable to performing detection and suppression in the Range spectrum. In order to detect and suppress RFI ambiguities in the range spectrum, the SAR SLC image data is transformed to the range spectrum by performing a Fast Fourier Transform in the range direction, instead of in the azimuth direction. The remaining steps of the method as described above are unchanged and serve to detect and suppress RFI ambiguities in the range spectrum rather than the Doppler spectrum.

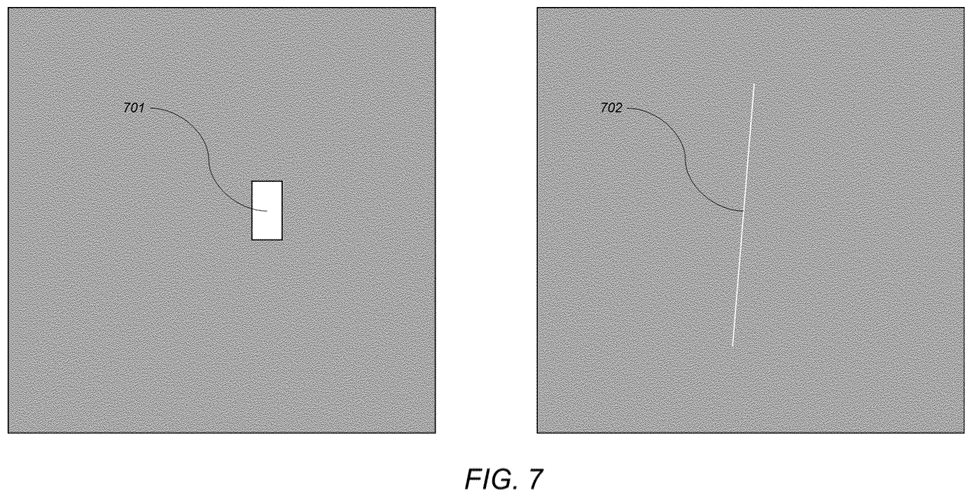

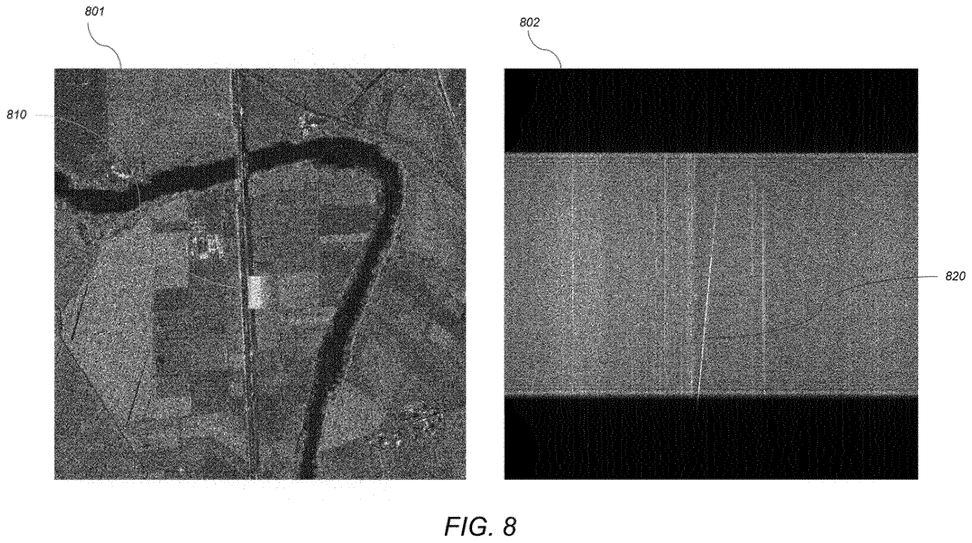

FIG. 7 shows a schematic of an azimuth ambiguity 701 in SAR SLC image data, and the corresponding ambiguity 702 in the Doppler spectrum transformed from the SAR SLC image data. FIG. 7 shows how the ambiguity is transformed between the image and frequency domain. FIG. 8 shows a similar arrangement, but with real data. In particular, FIG. 8 shows SAR SLC data 801 in the image domain and corresponding Doppler spectrum data 802 in the frequency domain. In the SAR SLC data 801 there is an azimuth ambiguity 810, which appears as a rectangular shape in the centre of the image. This azimuth ambiguity 810 is difficult to disambiguate from the non-ambiguous signal. Indeed, real features/targets may exist behind the azimuth ambiguity 810 that are obscured by the azimuth ambiguity. It is also unclear to what pixels the ambiguity 810 is constrained, since it is not clearly defined from the background. On the contrary, in the Doppler spectrum 802, the azimuth ambiguity 820 is much more easily recognisable from its distinctive shape and pattern (a slanted line) in comparison to the other features of the Doppler spectrum 802. It is thus much easier to distinguish the ambiguous signal from the non-ambiguous signal in the Doppler spectrum when compared to the SAR SLC data 801. For this reason, detection is improved when using the Doppler spectrum.

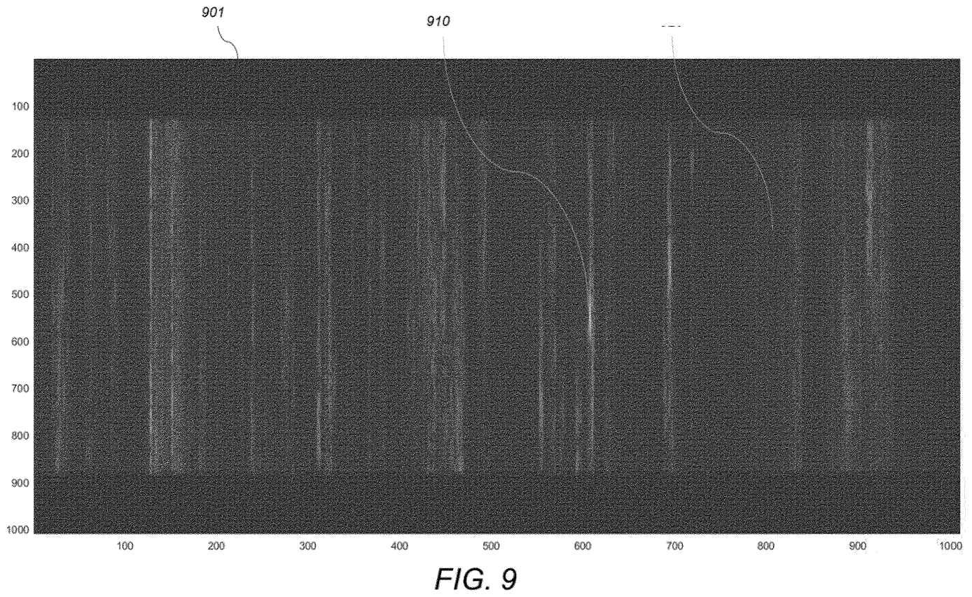

Detection may further be improved by applying a normalization filtering process as set out above. FIG. 9 illustrates an example Doppler spectrum 901 that has not been subject to the normalization filtering process. As can be seen from FIG. 9, there are several strong, high amplitude features such as strong feature 910, which appears very bright. The azimuth ambiguity 920 (seen as a faint slanted line) is, in comparison, relatively faint. This can make it harder to identify the azimuth ambiguity.

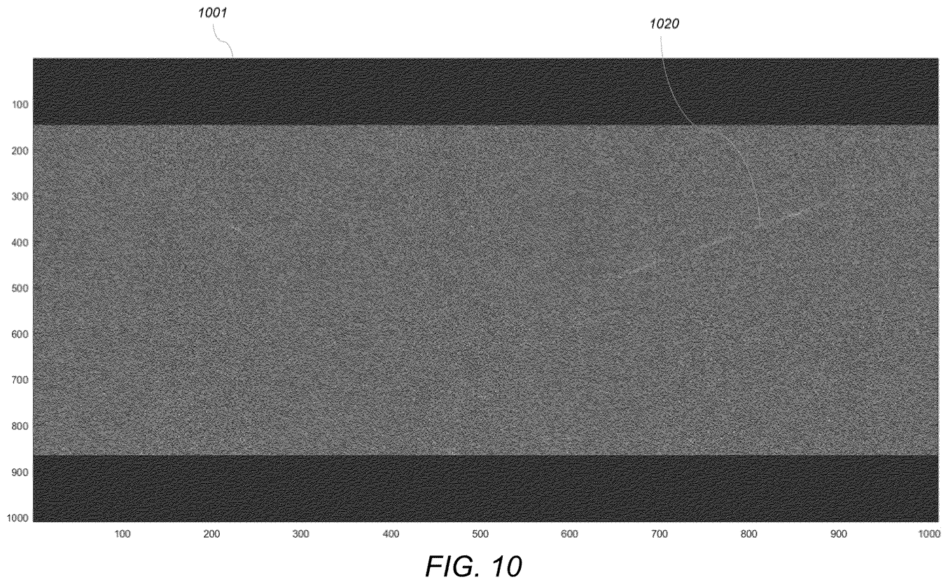

FIG. 10 illustrates a normalized Doppler spectrum 1001, wherein the normalization filtering process has been applied to the data. As can be seen from FIG. 10, there are no high amplitude features like in FIG. 9, and the azimuth ambiguity 1020 is much more clearly recognisable. The difference between FIGS. 9 and 10 show the advantage of the normalization process in clearly distinguishing azimuth ambiguities, which aids the detection process.

The ambiguity detection and the ambiguity suppression machine learning models will now be described. These models may form part of the same system, and thus may be considered one model, whereby the output of the ambiguity detection machine learning model is the input of the ambiguity suppression machine learning model. However, in some embodiments, as explained above, only one of these machine learning models is used.

The ambiguity detection machine learning model is configured to detect azimuth ambiguities present in Doppler spectra. The ambiguity detection model may include a neural network and more specifically, a convolutional neural network. This model may be based on the U-Net architecture, to provide precise segmentation between ambiguities and non-ambiguities. The U-Net architecture was set out originally in the paper ‘U-Net: Convolutional Networks for Biomedical Image Segmentation’ by O. Ronneberger, P. Fischer, and T Brox, University of Freiburg, Germany, 2015, to which reference is made here. The U-Net architecture is trained with at least 150 simulated training data sets of, for example, 1024*1024 pixels. This architecture can also be used to detect ambiguities in the image domain), but the performance is better in the frequency domain, which is preferred.

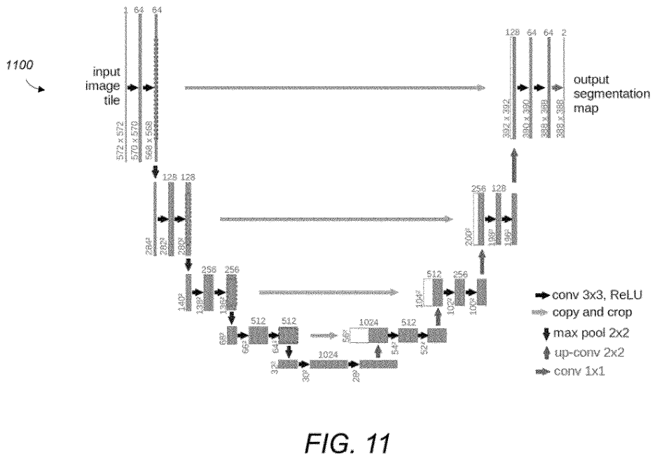

An example U-Net architecture 1100 is provided in FIG. 11. It is to be understood that this architecture is exemplary only and more or fewer inputs, outputs and layers may be included. In FIG. 11, the example U-Net includes: a Convolution Operation, Max Pooling, ReLU Activation, Concatenation and Up Sampling Layers and three sections, including: a contraction, bottleneck, and expansion section. In the example architecture 1100, there are 4 contraction blocks in the contraction section. Each contraction block is provided with an input, and applies two 3×3 convolution layers, ReLu layers and then a 2×2 max pooling layer. The number of feature maps doubles at each pooling layer. The bottleneck layer uses two 3×3 convolution layers and a 2×2 up-convolution layer. The expansion section includes several expansion blocks, whereby each block is configured to pass the input to two 3×3 convolution layers and a 2×2 upsampling layer that halves the number of feature channels. The expansion section also includes a concatenation with the correspondingly cropped feature map from the contracting path. At the end of the architecture, a 1×1 Conv layer is used to produce the number of feature maps required to match the number of segments which are desired in the output. Loss is computed for each pixel, but aggregated. A Softmax or sigmoid is applied to each pixel followed by a loss function. This converts the segmentation problem into a classification problem where each pixel of an input image is classified to one of the classes. In embodiments of the invention, each pixel of the Doppler spectrum is classified to be an ambiguity or not to be an ambiguity. When used in the frequency domain, the input to the ambiguity detection machine learning model is the Doppler spectrum amplitude, and when used in the image domain, the input to the ambiguity detection machine learning model is SAR amplitude.

The ambiguity detection machine learning model may also be implemented in a Residual U-Net configuration, or Resnet U-Net for example.

Although a U-Net and Resnet U-Net configuration are described above as example of the ambiguity detection machine learning model, it is to be understood that any semantic segmentation model may be used to segment the Doppler spectrum between ambiguities and non-ambiguities. Thus, any supervised or unsupervised machine learning model may be used, including for example, neural networks, classifiers, clustering algorithms and the like. The ambiguity detection model may also be an object or feature detection machine learning model trained to detect the presence of ambiguities in Doppler spectra.

The ambiguity detection machine learning model may be trained using conventional techniques. Additionally, the ambiguity detection machine learning model may be trained using training data generated by a SAR data simulator. Using a SAR simulator that provides data with simulated ambiguities can allow for more training data to be used to perform the training. It can also allow various types of ambiguities to be included in the training data that may be hard to obtain if not simulated and can also allow tuning of the data used for the training. All of this can help the ambiguity detection machine learning model to improve accuracy and the number and types of ambiguities that can be detected.

The ambiguity detection machine learning model is configured to use the Doppler spectrum/SAR image as an input, and then output an indication of the existence and position of ambiguities in the original Doppler spectrum. The indication may take the form of a segmented Doppler spectrum or a segmented SAR image. The indication comes from a two-dimensional, single channel image output by the ambiguity detection machine learning model, with each pixel having a probability for the pixel being a part of an ambiguity. This probability image is then thresholded to provide the indication of one or more ambiguities. For example, the threshold may require a probability of 0.3, 0.4, 0.5, 0.6 or more to be determined as an ambiguity.

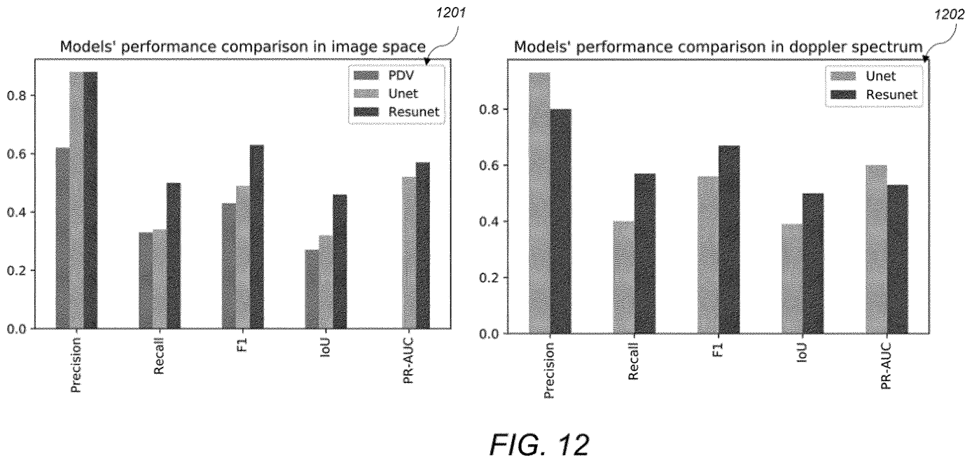

FIG. 12 shows two graphs that compare the ambiguity detection machine learning model against other approaches, across both the image domain in the first graph 1201, and the frequency domain in the second graph 1202.

The first graph 1201 compares the performance of a PDV (Phase Derivative Value) approach carried out in the image domain using analytical methods (not machine learning), to two machine learning methods according to the embodiments set out above. The machine learning models used are based on a Unet and Resnet architecture. The second graph 1202 shows the same machine learning models in the frequency domain. PDV is not suitable for use in the frequency domain. Each graph provides a score out of 1 corresponding to the fraction of correct predictions of ambiguities of each method vs the total number of ambiguities, taking into account false positives and negatives.

In particular, for each graph, the number of true positive, false positive, true negative and false negative pixels are computed. The measures provided on the x axis include the following. Precision is the fraction of predicted pixels that were correct, computed as (true positives)/(true positives+false positives). Recall is the fraction of interesting pixels that were predicted, computed as (true positives)/(true positives+false negatives). F1 score is the harmonic mean of precision and recall, typically used as a ‘combined’ metric. F1 is thus a number that takes into account both precision and recall and will be low if either are low and high only if both are high. IoU is another similar combined score. PR-AUC is precision-recall area under curve, which is an integral over a curve of precision and recall.

From the graphs 1201 and 1202, it is clear that both examples of the ambiguity detection machine learning models can detect ambiguities, both in the image domain and the frequency domain. Furthermore, both machine learning models out-perform the PDV non-machine learning method. Finally, the machine learning models perform better in the frequency domain, using the Doppler spectrum, when compared to the image domain. Thus the methods described above, with respect to ambiguity detection, perform better than conventional non-machine learning approaches.

As explained above, the output of the ambiguity detection machine learning model may be post-processed to form a segmented Doppler spectrum, using a mask or otherwise, to distinguish the areas of the Doppler spectrum that are not ambiguities from those that are. For example, pixels determined by the machine learning model, and in particular the ambiguity detection model, as belonging to an ambiguity may be reset to white. The original Doppler spectrum is thus modified by the masking of the detected ambiguities, such that the resultant Doppler spectrum may be considered a masked or segmented Doppler spectrum. This masking step may be performed as part of the output of the ambiguity detection model.

The segmented Doppler spectrum may then be used as the input to the ambiguity suppression machine learning model, which will now be described. It is however to be understood that it is not a requirement that the ambiguity detection machine learning model be used with the ambiguity suppression machine learning model, and alternatively, any suitable method, including conventional, non-machine learning methods of detecting ambiguities may be used in combination with the ambiguity suppression machine learning model.

The ambiguity suppression machine learning model is applied to a segmented image or Doppler spectrum, or any other dataset including an indication of one or more azimuth ambiguities. In an example, the ambiguity suppression machine learning model is applied to the segmented or masked Doppler spectrum that is output or produced subsequent to the output of the ambiguity detection machine learning model. The ambiguity suppression machine learning model is configured to suppress the detected azimuth ambiguities. The ambiguity suppression machine learning model may be a supervised or unsupervised machine learning model. For example, the ambiguity suppression machine learning model may be a convolutional neural network, such as a one-dimensional convolutional neural network or a two-dimensional neural network. The convolutional neural network may be trained or otherwise configured to perform inpainting on the detected ambiguities. Inpainting is the process of restoring images or datasets by filling in missing or corrupted parts of the image or dataset based on the surroundings of the missing or corrupted parts in the image or dataset. In an example, the convolutional neural network is a trained convolutional neural network that is trained using training data. In another example, the convolutional neural network of the ambiguity suppression model is a Deep image prior network that does not require prior training data. The ambiguity suppression model may comprise a generative adversarial network (GAN).

In an embodiment, a column median prior is used in a deep image prior style neural network architecture. The azimuth columns of the Doppler spectrum (along the y-axis of the Doppler spectrum) include the energy of the pulses and keeping this intact lessens degradation significantly. In particular, the energy of the azimuth columns should be kept as constant as possible during the process of suppression (except for the ambiguity), to avoid changing the resultant SAR SLC image excessively. The role of the column median prior is to cause the deep image prior network ‘search’ or ‘annealing’ to be more targeted, searching from where the ambiguity would be expected to be. This provides the benefits of speed of performance and performance itself to the suppression process. The prior is constructed by computing the median of each column of the corrupted Doppler amplitude spectrum and creating a corresponding 2D image of this.

The ambiguity suppression machine learning model is provided with the indication of the azimuth ambiguities, such as the segmented or masked Doppler spectrum, as its input, then performs inpainting on the detected ambiguities, to produce an impainted Doppler spectrum with no ambiguities. This inpainted Doppler spectrum is considered and referred to as a modified Doppler spectrum.

As noted above, the ambiguity detection model may be applied separately to the ambiguity suppression model.

Alternatively, the ambiguity detection machine learning model and the ambiguity suppression machine learning model may form part of the same machine learning model, such that the output of the ambiguity detection model is fed directly to the input of the ambiguity suppression model. In this regard, the machine learning model may have as its input the original Doppler spectrum, and as its output, the modified Doppler spectrum with no ambiguities present.

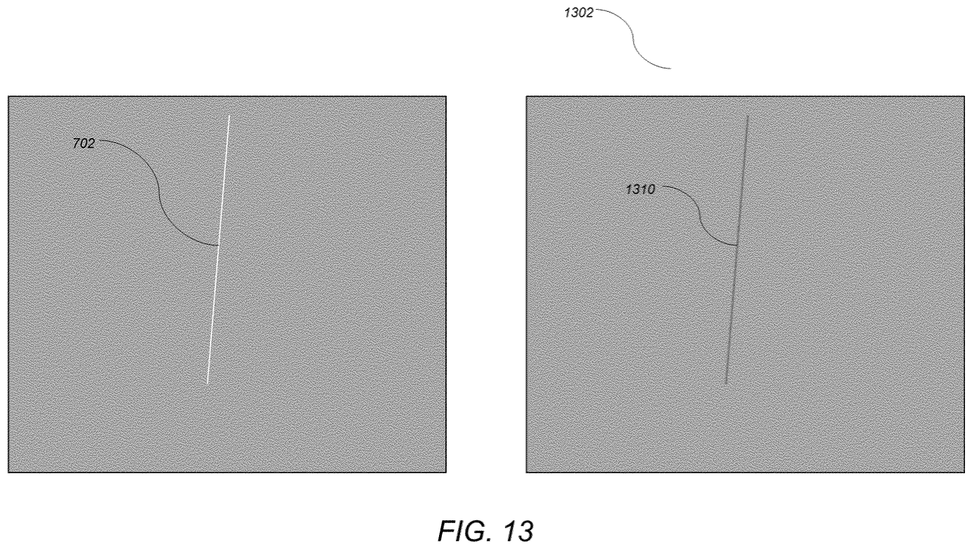

FIG. 13 shows an example schematic diagram of the azimuth ambiguity 702 of FIG. 7 in a masked Doppler spectrum, and a modified Doppler spectrum 1302 including an inpainted section 1310 (shading exaggerated for illustrative purposes). The inpainting is performed by the ambiguity suppression machine learning model.

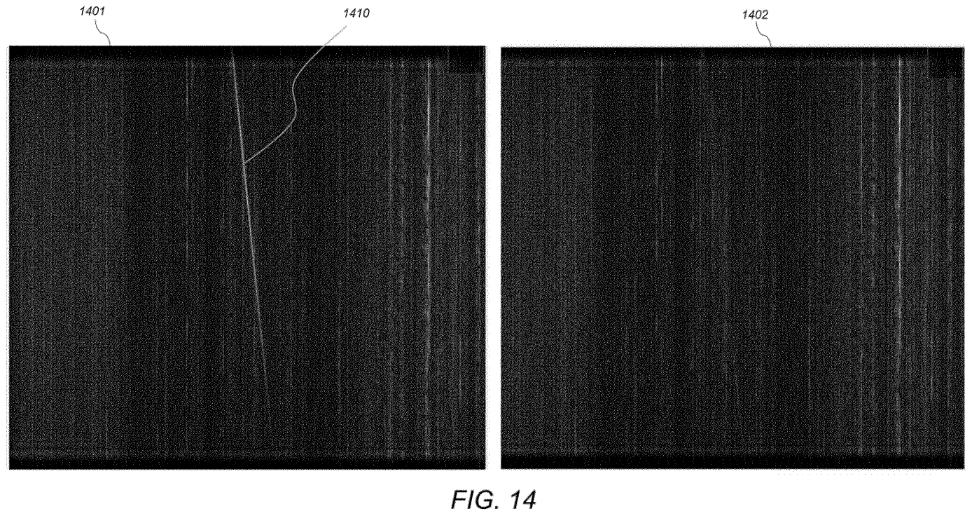

FIG. 14 shows an example diagram based on real data from a two-dimensional convolutional neural network with a U-Net architecture. In particular, FIG. 14 shows a Doppler spectrum 1401 in the frequency domain, including an identified ambiguity 1410. FIG. 14 shows a corresponding modified Doppler spectrum 1402, which has been inpainted using the ambiguity suppression machine learning model. As can be seen from the comparison between the Doppler spectrum 1401 and the modified Doppler spectrum 1402, the inpainting has successfully removed the ambiguity without affecting the remainder of the Doppler spectrum. In these frequency-domain images, the y axis is the doppler frequency, which represents azimuth, and the x axis is the range time, representing range.

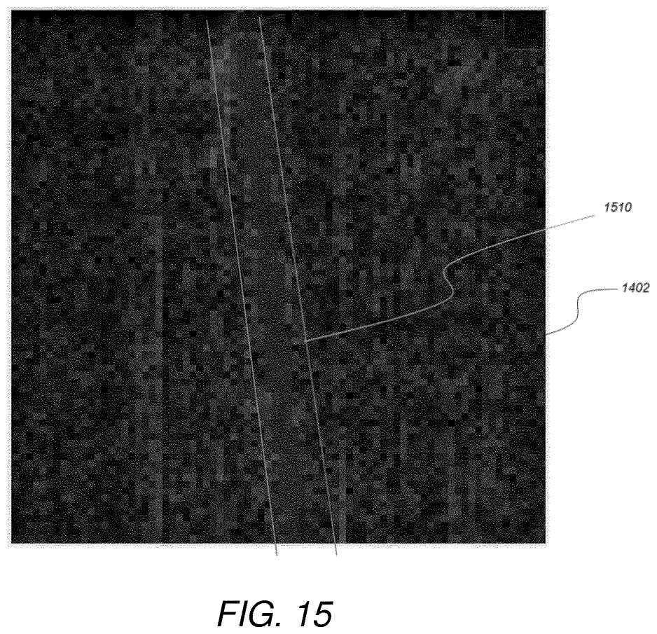

FIG. 15 shows a zoomed-in view of the inpainted region 1510 of the modified Doppler spectrum 1402 of FIG. 14. As can be seen from FIG. 15, the inpainted region is a good approximation of the surrounding pixels in the Doppler spectrum. This inpainting was performed by the 2D convolutional neural network with the U-Net architecture.

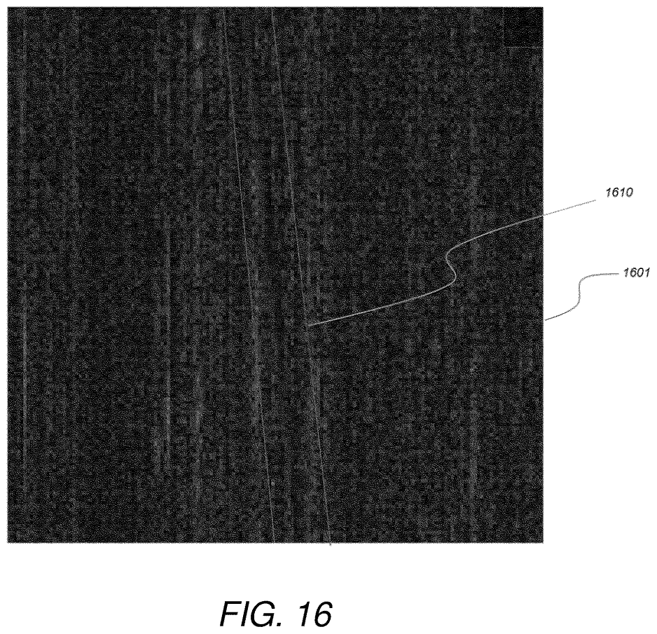

FIG. 16 shows a zoomed-in view of an inpainted region 1610 of a second modified Doppler spectrum 1601. As can be seen from FIG. 16, the inpainted region 1610 is a good approximation of the surrounding pixels in the Doppler spectrum. This inpainting was performed by a 1D convolutional neural network. The 1D convolutional neural network comprises 1D convolutional layers followed by SiLU activation layers and batch normalization layers. These repeat to form a funnel. Alternatively, any suitable network architecture may be used.

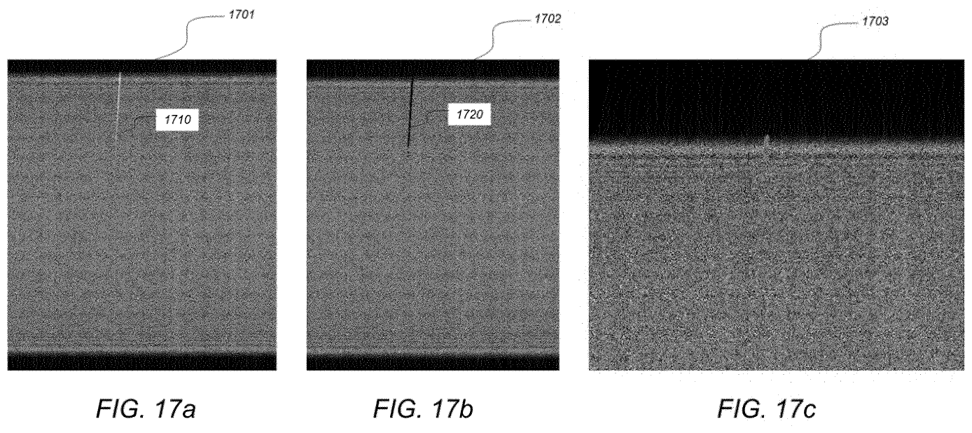

FIG. 17 shows three images of different steps in the suppression process, whereby the ambiguity suppression machine learning model has a Deep Image Prior architecture. In FIG. 17a, A Doppler spectrum is shown, including an ambiguity 1710. FIG. 17b shows a segmented or masked Doppler spectrum, after the process of detection has indicated, via indication 1720, the presence of an ambiguity. In FIG. 17b, the indication has been provided by masking out the pixels determined as belonging to an ambiguity. FIG. 17c shows a modified Doppler spectrum. In FIG. 17c, the ambiguity suppression machine learning model has been applied to suppress the detected ambiguity 1720. As can be seen in FIG. 17c, there is only a very minor artefact of the suppression process, and the ambiguity is largely no longer apparent in the modified Doppler spectrum 1703.

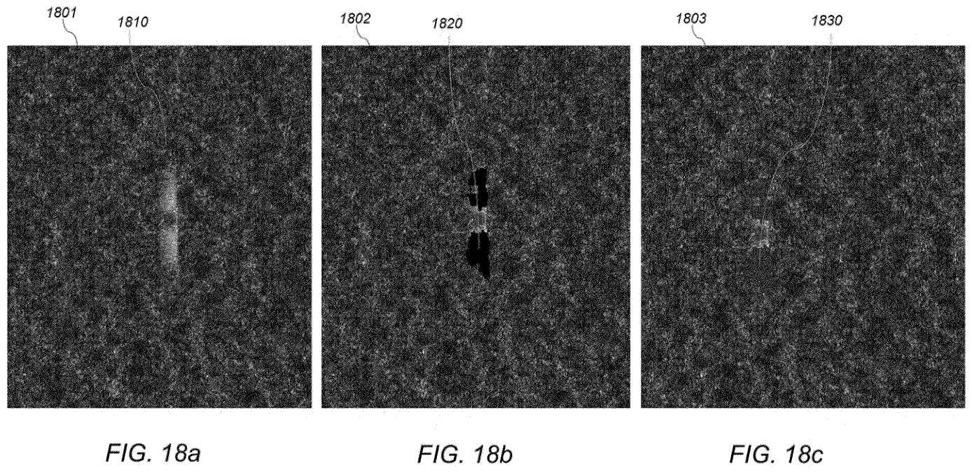

FIGS. 14 to 17 show that the ambiguity suppression machine learning model is very effective at suppressing detected ambiguities in the frequency domain, using inpainting enacted by a neural network. It is also possible to perform inpainting in the image domain. FIG. 18 shows three images of different steps in the suppression process, whereby the ambiguity suppression machine learning model has a Deep Image Prior architecture. The suppression is performed in the image domain. In particular, FIG. 18a shows an SAR SLC image 1801 with an ambiguity 1810. Compared to the Doppler spectrum, it is more difficult to determine the boundaries of the ambiguity. Indeed, FIG. 18b shows a masked/segmented image 1802 with a detected ambiguity 1820, which has been segmented (and in this case removed) from the image. FIG. 18c shows a modified SAR SLC image 1803 in which the detected ambiguity 1830 has been suppressed by the ambiguity suppression machine learning model. The suppression provides a better result than the original image 1801, but is not as useful as suppression in the frequency domain.

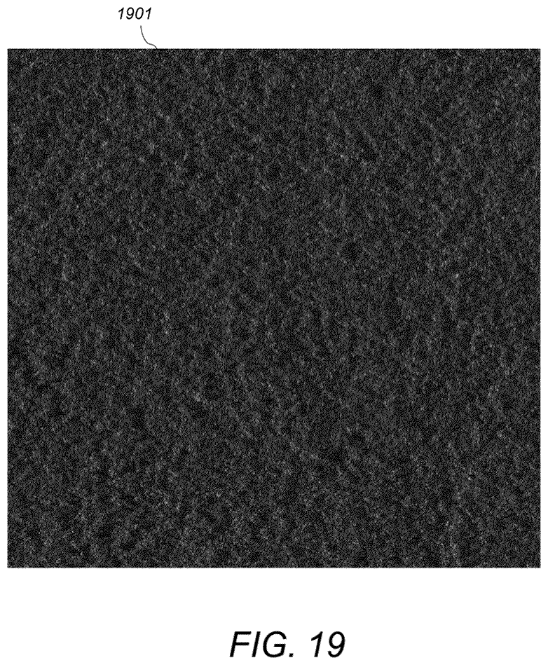

FIG. 19 shows a comparison SAR SLC image 1901, transformed from the frequency domain. In this instance, suppression was performed by the ambiguity suppression machine learning model in the frequency domain before being transformed back to the image domain. Comparing FIGS. 18c and 19, it is clear that suppression in the frequency domain using machine learning provides excellent results.

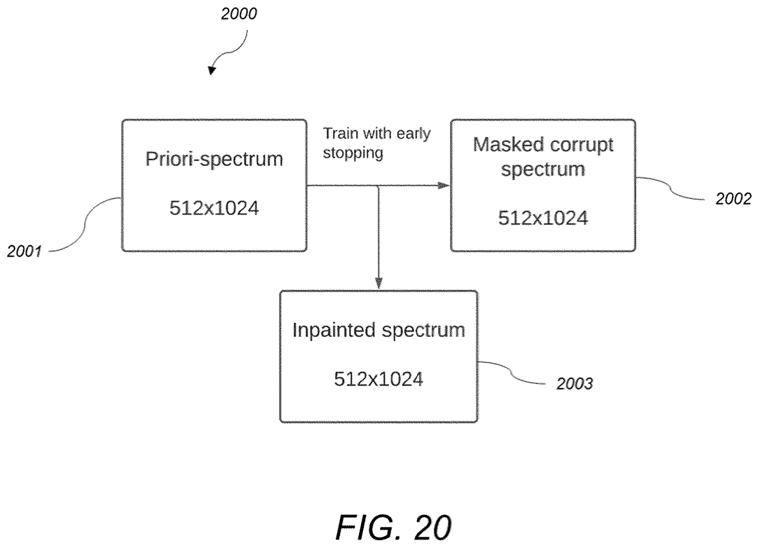

FIG. 20 shows a diagram 2000 of the inputs and outputs of the unsupervised Deep Image Prior network that may be used as the ambiguity suppression machine learning model. As can be seen in FIG. 20, the input to the Deep Image Prior network is a prior spectrum image 2001. In the example of FIG. 20, this has a size of 512×1024 pixels, although it is to be understood any size is suitable. The priori spectrum image 2001 is the azimuth column median spectrum described above, which is effectively an image the size of the Doppler spectrum but with each pixel replaced by the median value of each column in the original spectrum excluding the values inside the pixels comprising ambiguities. The pixels comprising ambiguities are identified using the detection mask (the masked Doppler spectrum). As described above, the masked Doppler spectrum 2002 is the original Doppler spectrum with the ambiguities masked out. To mask the ambiguities, the pixels containing ambiguities may be recoloured as white, for example. The basic principle of the Deep Image Prior is that it makes it easier for a bottleneck convolutional neural network to pass through values that look like images or have a consistent structure. The neural network is thus tasked to learn to convert from the priori spectrum image 2001 (including straight vertical lines with approximately the right energy) to the masked Doppler spectrum image 2002. Typically, most Doppler spectrum images comprise a speckle-like structure with vertical lines, and the neural network learns to let these features pass. The masked white areas of the masked Doppler spectrum image 2002 appear very inconsistent compared to the rest of the image, and as such the neural network only learns how to let those pass later in the learning process. Thus, the machine learning model is forced to stop learning before it learns how to let the detected ambiguities through (e.g. strong white regions). This process is called ‘early stopping’ and by doing this, an output image 2003 is produced whereby the speckle-like structure and vertical lines are let through but the ambiguities are not. The output image 2003 thus includes Doppler spectrum-like structure in the place of the ambiguities. These ‘early-stopping’ pixels from the output image 2003 are then used to replace the ambiguous masked pixels in the masked Doppler spectrum image 2002, to produce an inpainted final image, which comprises the original Doppler spectrum in pixels where no ambiguities were detected, and inpainted pixels from the output image 2003 where ambiguities were detected. The final inpainted image is also referred to as the modified Doppler spectrum.

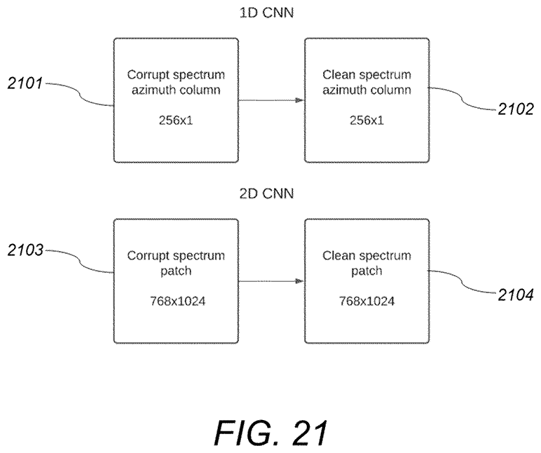

FIG. 21 shows a diagram of an example input 2101 and output 2102 by the 1D convolutional neural network and an example input 2103 and output 2104 by the 2D convolutional neural network, when these types of networks are used for the ambiguity suppression machine learning model. As can be seen from FIG. 21, the 1D CNN has an input 2101 that is an azimuth column of the masked Doppler spectrum image, with a size of 256×1. The output 2102 of the 1D CNN is a corresponding clean Doppler spectrum azimuth column. The 1D CNN repeats this process for all azimuth columns of the masked Doppler spectrum, and for all detected pixels. The 2D CNN has an input 2103 that is a patch of the masked Doppler spectrum, with a size of 768×1024 pixels. The patch may thus be a smaller portion of the masked Doppler spectrum image than the entire image. The output 2104 of the 2D CNN is a corresponding clean Doppler spectrum patch. It is to be understood that the image sizes here are exemplary and any image size may be used. Both of the 1D and 2D CNNs are trained using training data pairs, whereby the first of the pair is a non-corrupted Doppler spectrum training image and the second of the pair is the same Doppler spectrum training image with a simulated ambiguity. The CNNs are trained to remove the ambiguity so as to obtain an output image that is most similar to the non-corrupted image of the pair, (without distorting other parts of the image).

As described above, the ambiguity suppression machine learning model may be unsupervised, or supervised and trained using training data. As with the ambiguity detection machine learning model, the ambiguity suppression machine learning model may be trained using training data generated by a SAR data simulator. Using a SAR simulator that provides data with simulated ambiguities can allow for more training data to be used to perform the training. It can also allow various types of ambiguities to be included in the training data that may be hard to obtain if not simulated and can also allow tuning of the data used for the training. All of this can help the ambiguity detection machine learning model to improve accuracy and the number and types of ambiguities that can be detected.

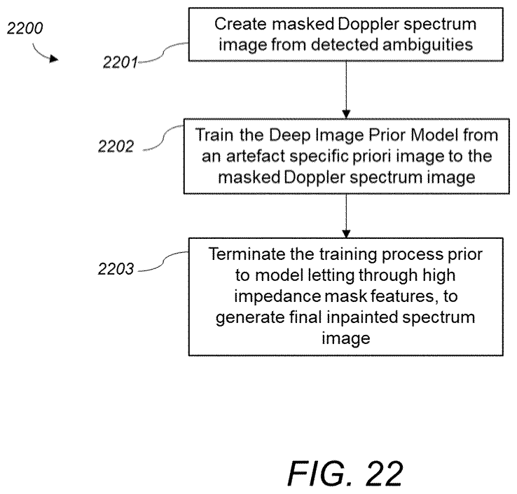

A method 2200 of suppressing azimuth or RFI ambiguity using the above-described Deep Image Prior ambiguity suppression machine learning model, according to various embodiments, is now described with reference to FIG. 22.

In a first step 2201, a suitable azimuth or RFI ambiguity detection algorithm, or ambiguity detection machine learning model, (as described above) is used to create a masked or segmented Doppler spectrum. To create the masked or segmented Doppler spectrum, the detection algorithm generates an artefact mask for the original Doppler spectrum, and removes the masked part of the spectrum according to the artefact mask, creating an unnatural high impedance region corresponding to the ambiguity. This creates the masked Doppler spectrum image.

In a second step 2202, a 2D convolutional neural network from an artefact specific priori image is trained to the masked Doppler spectrum image. The convolutional neural network will first let through low impedance features similar to those of the priori image, such as vertical lines and speckle-like structures typical of Doppler spectra, and only starts to learn how to replicate the high impedance mask corresponding to the ambiguities after the training process has been performed for an extended period of time.

In a third step 2203, the training process is terminated before the model lets through the high impedance masked features. This ‘early stopping’ of the training process means that the masked area is filled with a texture derived from other spectral image features. Combining this inpainting with the remainder of the masked Doppler spectrum that does not include ambiguities provides the final inpainted spectrum image, otherwise referred to as the modified Doppler spectrum.

Optionally the cleaned modified Doppler spectrum can then be converted to a clean SAR image, representing the corrected data.

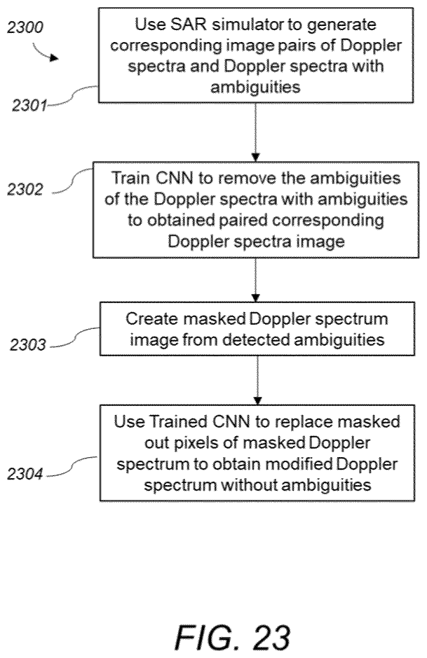

A method 2300 of suppressing azimuth or RFI ambiguity using the above described 1D and 2D CNN machine learning model, according to various embodiments, is now described with reference to FIG. 23.

In a first step 2301, a SAR simulator is used to generate ambiguities and/or RFI artifacts on real SAR image Doppler spectra. Each original non-corrupted Doppler spectrum forms one image and the generated Doppler spectrum with ambiguities and/or RFI artifacts forms another image, whereby these two images form a corresponding pair.

In a second step 2302, a convolutional neural network, such as a 1D CNN or 2D CNN is trained to map from the generated Doppler spectrum with ambiguities and/or RFI artefacts to the original Doppler spectrum, for one or more of the pair of images.

In a third step 2303, during inference time, a separate suitable ambiguity or RFI detection algorithm or machine learning model is used to create a masked Doppler spectrum from a Doppler spectrum, whereby the masked Doppler spectrum masks out the detected ambiguities.

In a fourth step 2304, the CNN trained in the second step 2302 is used to replace all pixels masked out in the masked Doppler spectrum, (the pixels where ambiguities were detected). This will produce a modified Doppler spectrum which can then optionally be converted to a clean SAR image.

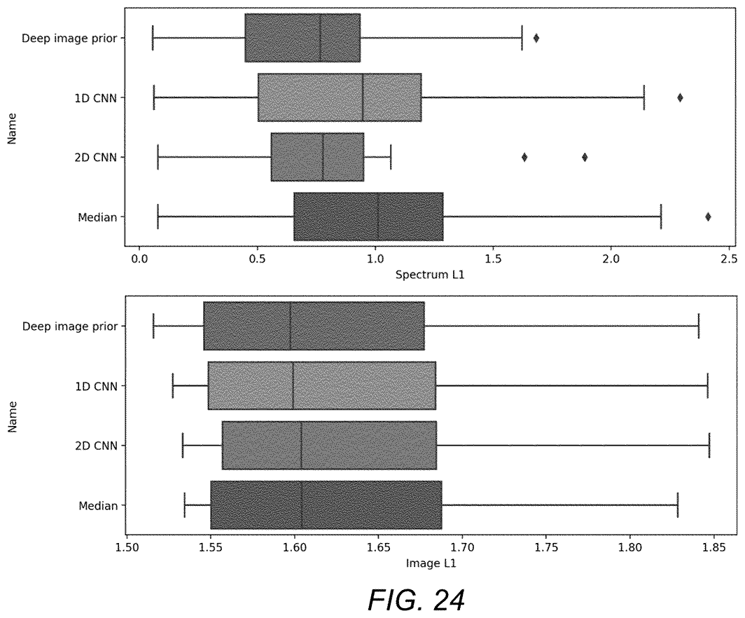

FIG. 24 is a graph that shows a numeric comparison of the suppression results of the three different ambiguity suppression machine learning models (Deep Image Prior, 1D CNN, 2D CNN) on a test set of 15 ambiguity simulations. From FIG. 24, it is clear that Deep Image Prior Unsupervised technique provided the best results, but good results are still obtained by the 1D and 2D CNN. As described above, the ambiguity suppression machine learning model may include the Deep Image Prior, 1D CNN, or 2D CNN, but equally may include any suitable neural network architecture. Furthermore, the ambiguity suppression machine learning model may be combined with the ambiguity detection machine learning model described above, or may be combined with any classical ambiguity detection algorithm.

The methods described here may be performed on any suitable computer device, having a processor and memory.

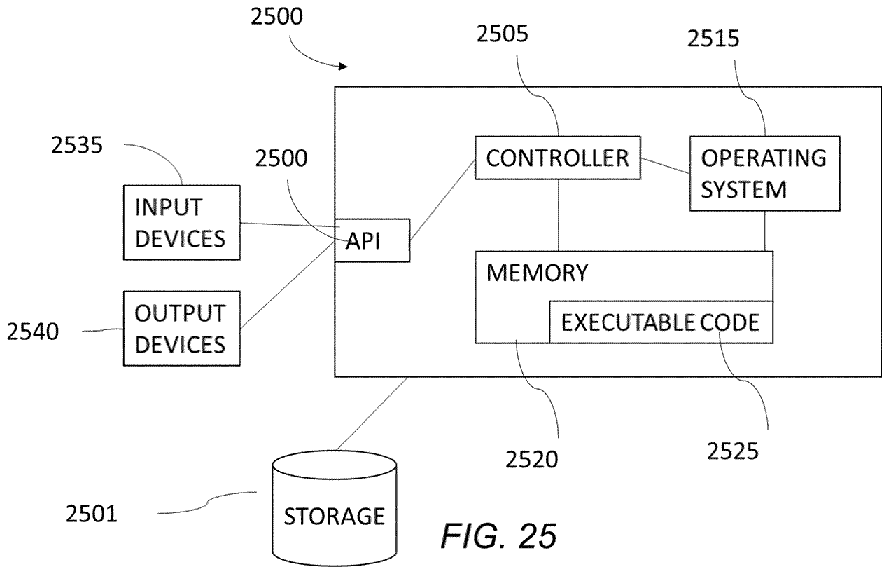

FIG. 25 shows a schematic diagram of a computing system 2500 according to various embodiments, on which any of the above-described methods may be performed. In particular, the Computing system 2500 may comprise a single computing device or components such as a laptop, tablet, desktop or other computing device. Alternatively functions of system 2500 may be distributed across multiple computing devices.

The Computing system 2500 may include one or more controllers such as controller 2505 that may be, for example, a central processing unit processor (CPU), a chip or any suitable processor or computing or computational device such as an FPGA mentioned, an operating system 2515, a memory 2520 storing executable code 2525, storage 2530 which may be external to the system or embedded in memory 2520, one or more input devices 2535 and one or more output devices 2540.

One or more processors in one or more controllers such as controller 2505 may be configured to carry out any of the methods described here. For example, one or more processors within controller 2505 may be connected to memory 2520 storing software or instructions that, when executed by the one or more processors, cause the one or more processors to carry out a method according to some embodiments of the present invention. Controller 2505 or a central processing unit within controller 2505 may be configured, for example, using instructions stored in memory 2525, to perform some of the operations as set out in FIGS. 3 to 6. The machine learning model of various embodiments may be stored in the memory 2525, for example.

SAR data may be received at a processor comprised in the controller 2505 which then controls the subsequent operations of FIGS. 2 to 6 and any of the above-described methods according to one or more commands or processes which may be stored as part of the executable code 2525.

Input devices 2535 may be or may include a mouse, a keyboard, a touch screen or pad or any suitable input device. It will be recognized that any suitable number of input devices may be operatively connected to computing system 2500 as shown by block 2535. Output devices 2540 may include one or more displays, speakers and/or any other suitable output devices. It will be recognized that any suitable number of output devices may be operatively connected to computing system 2500 as shown by block 2540. The input and output devices may for example be used to enable a user to select information, e.g., images and graphs as shown here, to be displayed.

In the embodiments described above, the computing device or system may comprise a single server or network of servers. In some examples, the functionality of the server may be provided by a network of servers distributed across a geographical area, such as a worldwide distributed network of servers.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray® disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device in FIG. 1, it will be appreciated that the computing device may be located remotely and accessed via a network or other communication link (for example using a communication interface). The data processing related to the embodiments described here may take place at the ground station 195, or another location on Earth, for example in communication with the ground station 195. Alternatively, some or all of the operations described here may be performed at an on-board computing system, if sufficient processing power is available. The data processing may use all the pulses transmitted during the integration time to focus the data in the azimuth direction. The methods described here are particularly but not exclusively suited to implementation in connection with a SAR carried on a satellite.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer-implemented method of detecting and suppressing azimuth ambiguities in synthetic aperture radar “SAR” single look complex image data, the method comprising:
obtaining SAR single look complex image data;
transforming the SAR single look complex image data to obtain a Doppler spectrum in the frequency domain for detecting azimuth ambiguities, wherein transforming the single look complex image data to obtain a Doppler spectrum comprises performing a Fourier transform operation in the azimuth direction on the image data,
extracting phase information from the Doppler spectrum;
detecting, in the Doppler spectrum, one or more azimuth ambiguities; and
suppressing the one or more azimuth ambiguities to obtain corrected data, wherein,
the suppressing comprises applying an ambiguity suppression machine learning model; and
reinstating the phase information after suppressing the azimuth ambiguities such that the phase information of the Doppler spectrum is conserved.

2. (canceled)

3. The method of claim 1, wherein detecting the one or more azimuth ambiguities comprises applying an ambiguity detection machine learning model, configured to detect the one or more azimuth ambiguities, to the Doppler spectrum to output an indication of one or more azimuth ambiguities in the Doppler spectrum;
wherein suppressing the one or more azimuth ambiguities comprises using the indication of the one or more azimuth ambiguities output by the ambiguity detection machine learning model to suppress the one or more azimuth ambiguities to obtain corrected data.

4. The method of claim 3, wherein suppressing comprises either:
suppressing the one or more azimuth ambiguities in the Doppler spectrum to obtain a modified Doppler spectrum; and
transforming the modified Doppler spectrum to obtain the corrected data, wherein the corrected data is image data; or
transforming the Doppler spectrum, including the indication of the one or more azimuth ambiguities output by the ambiguity detection machine learning model, to single look complex image data including a transformed indication of the one or more azimuth ambiguities; and
suppressing the one or more azimuth ambiguities in the single look complex image data including the transformed indication to obtain the corrected data, wherein the corrected data is image data;
wherein transforming the Doppler spectrum to obtain single look complex image data or the modified Doppler spectrum to obtain the corrected data, comprises performing an inverse Fourier transform operation on the Doppler spectrum or modified Doppler spectrum.

5. The method of claim 3, wherein suppressing comprises applying a non-machine learning suppression algorithm to suppress the one or more azimuth ambiguities.

6. The method of claim 3, wherein suppressing the one or more azimuth ambiguities comprises: applying the ambiguity suppression machine learning model, configured to suppress the one or more azimuth ambiguities, using the indication of the one or more azimuth ambiguities output by the ambiguity detection machine learning model.

7. The method of claim 1, wherein the ambiguity suppression machine learning model; is configured to suppress the one or more azimuth ambiguities, to obtain the corrected data.

8. The method of claim 7, wherein detecting the one or more azimuth ambiguities comprises applying a non-machine learning detection algorithm to output an indication of one or more azimuth ambiguities in the Doppler spectrum.

9. The method of claim 8 wherein suppressing comprises either:
suppressing, with the ambiguity suppression machine learning model, the one or more azimuth ambiguities in the Doppler spectrum to obtain a modified Doppler spectrum; and
transforming the modified Doppler spectrum to obtain the corrected data, wherein the corrected data is image data; or
transforming the Doppler spectrum, including the indication of the one or more azimuth ambiguities output by the non-machine learning detection algorithm, to single look complex image data including a transformed indication of the one or more azimuth ambiguities; and
suppressing, with the ambiguity suppression machine learning model, the one or more azimuth ambiguities in the single look complex image data including the transformed indication to obtain the corrected data, wherein the corrected data is image data.

10. The method of claim 1, further comprising masking the one or more detected azimuth ambiguities in the Doppler spectrum to produce a masked Doppler spectrum prior to suppressing, such that suppressing is performed based on the masked Doppler spectrum.

11. The method of claim 3, wherein the ambiguity detection machine learning model comprises a U-Net convolutional neural network or a Residual U-Net convolutional neural network trained to detect azimuth ambiguities in Doppler spectra using detection training data, wherein the detection training data is generated using a SAR data simulator.

12. (canceled)

13. (canceled)

14. (canceled)

15. The method of claim 1, wherein the ambiguity suppression machine learning model comprises a convolutional neural network.

16. The method of claim 15 wherein the convolutional neural network of the ambiguity suppression machine learning model comprises a generative adversarial network.

17. The method of claim 15 wherein the convolutional neural network of the ambiguity suppression machine learning model is a Deep image prior convolutional neural network, configured to perform inpainting on detected azimuth ambiguities.

18. The method of claim 15, wherein the convolutional neural network of the ambiguity suppression machine learning model is a trained one-dimensional or two-dimensional convolutional neural network configured to perform inpainting on detected azimuth ambiguities;
wherein the convolutional neural network is trained using suppression training data generated using a SAR simulator.

19. (canceled)

20. (canceled)

21. (canceled)

22. (canceled)

23. The method of claim 1, wherein the one or more azimuth ambiguities comprise radio frequency interference ambiguities and the frequency domain spectrum comprises a range spectrum.

24. The method of claim 1, wherein the ambiguity suppression machine learning model is a supervised or unsupervised machine learning model.

25. The method of claim 1, further comprising:
normalizing the SAR single look complex image data;
receiving SAR raw data signals and converting the SAR raw data signals to obtain the SAR single look complex image data; and
producing an image using the corrected data.

26. (canceled)

27. (canceled)

28. (canceled)

29. A computer-implemented method of suppressing azimuth ambiguities in synthetic aperture radar “SAR” single look complex image data, the method comprising:
transforming the single look complex image data to obtain the Doppler spectrum in the frequency domain, the transforming comprising performing a Fourier transform operation in the azimuth direction on the image data;
extracting phase information from the Doppler spectrum;
obtaining indications of one or more azimuth ambiguities in SAR single look complex image data or in a Doppler spectrum data set;
suppressing, the one or more azimuth ambiguities to obtain corrected data, the suppressing comprising applying an ambiguity suppression machine learning model configured to suppress azimuth ambiguities in SAR single look complex image data or in Doppler spectra; and
reinstating the phase information after suppressing the azimuth ambiguities such that the phase information of the Doppler spectrum is conserved.

30. A computing system comprising one or more processors configured to perform the method of claim 1.

31. A computer-readable medium comprising instructions which, when executed by a processor, cause the processor to carry out the method of claim 1.
